(19) United States
(12) Patent Application Publication
(10) Pub. No.: US 2026/0116016 A1
(43) Pub. Date: Apr. 30, 2026

(54) METHOD OF MANUFACTURING ELECTRODE

(71) Applicant: TOYOTA JIDOSHA KABUSHIKI KAISHA, Toyota-shi (JP)

(72) Inventors: Koji KASAHARA, Toyota-shi (JP); Koichi YANASE, Nagoya-shi (JP)

(73) Assignee: TOYOTA JIDOSHA KABUSHIKI KAISHA, Toyota-shi (JP)

(21) Appl. No.: 19/225,326

(22) Filed: Jun. 2, 2025

(30) Foreign Application Priority Data
Oct. 25, 2024 (JP) 2024-187863

(51) Int. Cl. B29C 65/16; B29C 65/00; B29L 31/34; H01M 4/04

(52) U.S. Cl. CPC B29C 65/1638; B29C 66/742; H01M 4/043; B29L 2031/3468

(57) ABSTRACT

A first aspect of the present disclosure relates to a method of manufacturing an electrode. The method includes a laminating step of laminating a thermoplastic resin material on a peripheral edge portion of a metal foil, a first welding step of irradiating a first region among a plurality of regions obtained by dividing a region on the resin material in a direction intersecting with a circumferential direction of the resin material with laser light to melt the resin material and welding the metal foil and the resin material to each other, and a second welding step of irradiating a second region different from the first region among the regions with the laser light after the first welding step to melt the resin material and welding the metal foil and the resin material to each other.

### CROSS-REFERENCE TO RELATED APPLICATION

This application claims priority to Japanese Patent Application No. 2024-187863 filed on Oct. 25, 2024. The disclosure of the above-identified application, including the specification, drawings, and claims, is incorporated by reference herein in its entirety.

### BACKGROUND

### 1. Technical Field

The present disclosure relates to a method of manufacturing an electrode.

### 2. Description of Related Art

In Japanese Unexamined Patent Application Publication No. 2024-068447 (JP 2024-068447 A), a heating device is moved relative to a resin material when the resin material disposed on a current collector foil is heated and the current collector foil and the resin material are welded. As a result, a method of manufacturing an electrode is disclosed in which the current collector foil and the resin material are welded while a position at which the resin material is heated is moved.

### SUMMARY

However, in the method of manufacturing the electrode disclosed in JP 2024-068447 A, a thermal shrinkage amount is different between the current collector foil and the resin material. Therefore, the current collector foil may be deformed during welding, and the welding between the current collector foil and the resin material may be incomplete.

The present disclosure has been made in view of the above circumstances, and provides a method of manufacturing an electrode that improves processing accuracy when a metal foil and a resin material are welded.

A method of manufacturing an electrode according to a first aspect is a method of manufacturing an electrode in which a metal foil is coated with a resin material having thermoplasticity. The method includes
a laminating step of laminating the resin material on a peripheral edge portion of the metal foil,
a first welding step of irradiating a first region among a plurality of regions with laser light when a region on the resin material is divided into the regions in a direction intersecting with a circumferential direction of the resin material to melt the resin material and then welding the metal foil and the resin material to each other, and
a second welding step of irradiating a second region different from the first region among the regions with the laser light after starting the first welding step to melt the resin material and then welding the metal foil and the resin material to each other.

According to the present disclosure, it is possible to provide the method of manufacturing an electrode that improves processing accuracy when the metal foil and the resin material are welded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic perspective view of an electrode according to an embodiment of the present disclosure;

FIG. 1B is a top view of an electrode according to the embodiment of the present disclosure;

FIG. 1C is a cross-sectional view of an electrode according to the embodiment of the present disclosure;

FIG. 2 is a flowchart of a method of manufacturing an electrode according to the embodiment of the present disclosure;

FIG. 3A is a cross-sectional view of a fixing step in the method of manufacturing an electrode according to the embodiment of the present disclosure;

FIG. 3B is a cross-sectional view of a first welding step in the method of manufacturing the electrode according to the embodiment of the present disclosure;

FIG. 3C is a cross-sectional view after the first welding step is executed in the method of manufacturing the electrode according to the embodiment of the present disclosure;

FIG. 4 is a plan view showing a divided region on a resin material in the method of manufacturing an electrode according to the embodiment of the present disclosure;

FIG. 5A is a cross-sectional view of a second welding step in the method of manufacturing the electrode according to the embodiment of the present disclosure;

FIG. 5B is a cross-sectional view after the second welding step is executed in the method of manufacturing the electrode according to the embodiment of the present disclosure; and

FIG. 6 is a cross-sectional view of a welding step in a method of manufacturing a conventional electrode.

### DETAILED DESCRIPTION OF EMBODIMENTS

Hereinafter, specific embodiments of the present disclosure will be described in detail with reference to the drawings. However, the present disclosure is not limited to the following embodiments. Further, in order to clarify the explanation, the following description and drawings are appropriately simplified.

### Configuration of Electrode

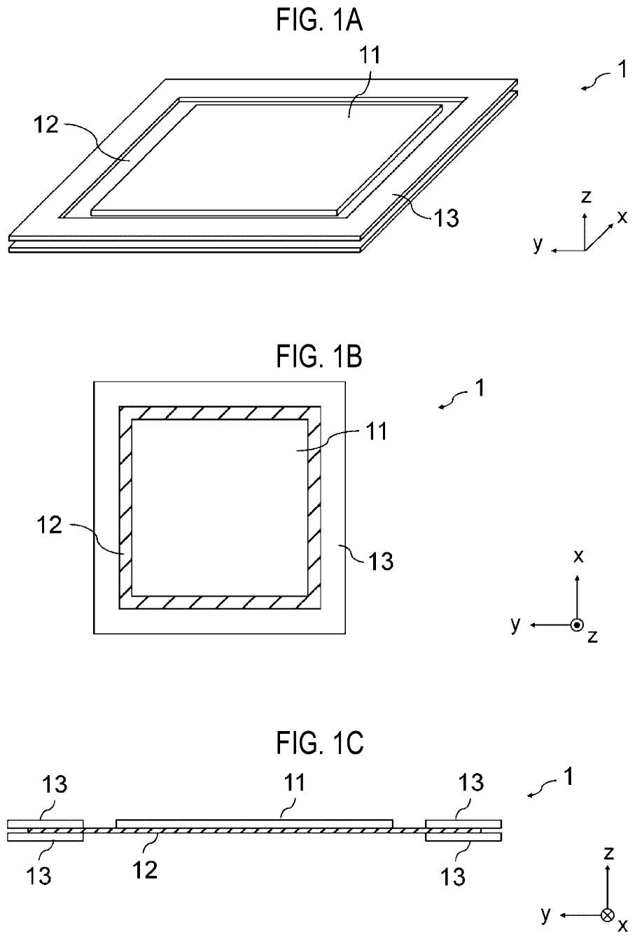

FIG. 1A is a schematic perspective view of an electrode according to an embodiment of the present disclosure. FIG. 1B is a top view of an electrode according to the embodiment of the present disclosure. FIG. 1C is a cross-sectional view of an electrode according to the embodiment of the present disclosure. The right-handed xyz orthogonal coordinates shown in FIG. 1A are for convenience of showing the positional relationship between the components. In FIG. 1A, a z-axis positive direction is a vertical upward direction, an xy plane is a horizontal plane, and FIGS. 1A to 1C and FIGS. 3A to 6 to be described later are common between FIGS. 1A to 1C and FIGS. 3A to 6.

The electrode 1 includes an active material layer 11, a current collector foil 12, and a resin material 13. Here, the current collector foil 12 is a metal foil. The electrode 1 is an electrode that can be formed by laminating a plurality of electrodes, and is, for example, an electrode laminate that is used in a secondary battery, such as a lithium ion secondary battery or a nickel-hydrogen battery. The size of the electrode 1 is appropriately determined in accordance with the size of the target secondary battery.

The active material layer 11 is provided on the surface of the current collector foil 12. The active material layer 11 contains an active material, and for example, in a case where the active material layer 11 is a positive electrode, the active material layer 11 contains a positive electrode active material, such as lithium cobalt oxide, lithium nickel oxide, or lithium manganese oxide. On the other hand, in a case where the active material layer 11 is used as a negative electrode, the active material layer 11 contains a negative electrode active material, such as carbon, graphite, or lithium titanate. The active material layer 11 may further optionally contain an electrolyte, a conductive aid, and a binder.

The size of the active material layer 11 in the xy plane direction is appropriately determined in accordance with the size of the desired electrode 1. In addition, the thickness of the active material layer 11 in the z-axis direction is a thickness at which the resin material 13 can play a role as a sealing material of the electrode laminate when a plurality of the electrodes 1 are laminated to form the electrode laminate. That is, when a plurality of the electrodes 1 are laminated, it is preferable that the distance between the current collector foils 12 is equal to the thickness of the resin material 13, and the thickness of the active material layer 11 is equal to or less than the interlayer distance.

In FIG. 1C, the active material layer 11 is provided on the z-axis positive direction side surface of the current collector foil 12, but the active material layer 11 may be provided on the z-axis negative direction side surface. Further, the active material layer 11 may be provided on the z-axis positive direction side surface and the z-axis negative direction side surface of the current collector foil 12. At this time, for example, the active material layer 11 containing a positive electrode active material is provided on the z-axis positive direction side surface of the current collector foil 12, and the active material layer 11 containing a negative electrode active material is provided on the z-axis negative direction side surface of the current collector foil 12, whereby the electrode 1 is configured as a bipolar electrode as a whole.

The current collector foil 12 is formed with the active material layer 11 on the surface. Further, as shown in FIG. 1C, the resin material 13 is welded to the peripheral edge portion of the current collector foil 12. The size of the current collector foil 12 is appropriately determined in accordance with the size of the electrode 1 to be obtained. The material of the current collector foil 12 is, for example, a metal such as aluminum or copper.

The resin material 13 is welded to the peripheral edge portion of the current collector foil 12. The resin material 13 functions as a sealing material capable of preventing the leakage of the electrolyte injected into the space around the active material layer 11 when a plurality of the electrodes 1 are stacked to form the electrode laminate. The resin material 13 contains a thermoplastic resin. Examples of the thermoplastic resin include an olefin-based resin, such as polyethylene or polypropylene, polyethylene terephthalate, and an acrylic resin.

The resin material 13 has a size and a z-axis direction thickness that allow the resin material 13 to appropriately play a role as a sealing material of the electrode laminate when a plurality of the electrodes 1 are laminated to configure the electrode laminate. In addition, in FIG. 1A and FIG. 1C, the resin material 13 is welded to the z-axis positive direction side and the negative z-axis direction side of the peripheral edge portion of the current collector foil 12, but the resin material 13 may be welded to any one of the z-axis positive direction side and the negative z-axis direction side of the peripheral edge portion of the current collector foil 12. In addition, in FIG. 1A and FIG. 1C, the end surface of the current collector foil 12 is exposed, but the end surface may be covered with the resin material 13.

### Method of Manufacturing Electrode

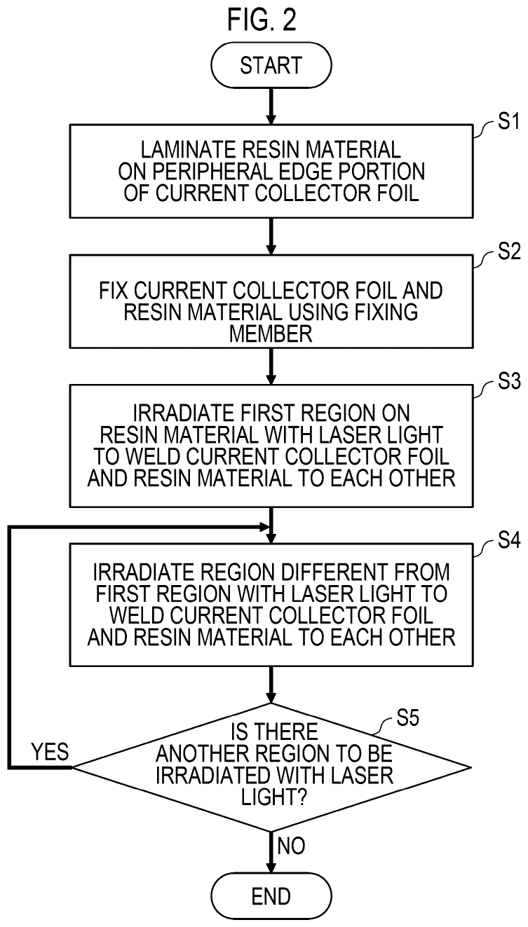

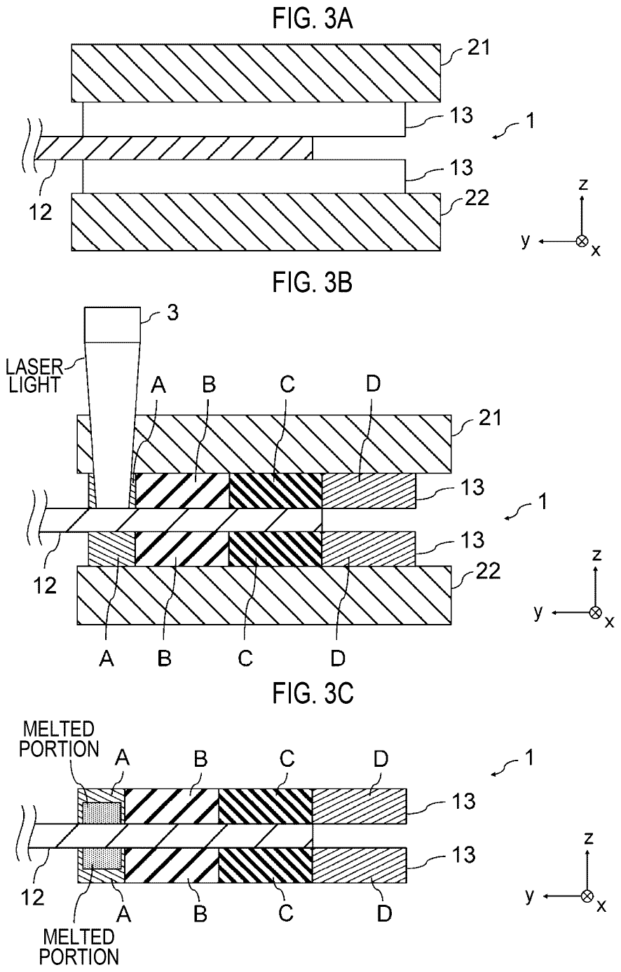

Next, a method of manufacturing an electrode according to the embodiment of the present disclosure will be described with reference to FIGS. 2 to 6. FIG. 2 is a flowchart of a method of manufacturing an electrode according to the embodiment of the present disclosure. FIGS. 3A to 6 show enlarged views of a y-axis negative direction side end portion of the electrode 1 shown in FIG. 1C.

First, the resin material 13 is laminated on the peripheral edge portion of the current collector foil 12 (S1). For example, as shown in FIG. 1C, when the resin material 13 is welded to the z-axis positive direction side and the z-axis negative direction side of the peripheral edge portion of the current collector foil 12, the first resin material 13, the current collector foil 12, and the second resin material 13 are laminated in this order. S1 is executed by a manufacturing device having a holding unit that can hold the current collector foil 12 and the resin material 13, for example.

Next, as shown in FIG. 3A, the laminated current collector foil 12 and the resin material 13 are fixed using the fixing members 21, 22 (S2). In S2, for example, the fixing member 21 is pressurized from the z-axis positive direction side, and the fixing member 22 is installed on a flat surface, whereby the current collector foil 12 and the resin material 13 are fixed. Note that the pressure value added when the current collector foil 12 and the resin material 13 are fixed is appropriately determined. The fixing members 21, 22 are pressurized by an air cylinder or the like.

The material of the fixing member 21 is preferably a material permeable to laser that is emitted from the z-axis positive direction side, that is, the fixing member 21 side in S3 described below. Transmitting the laser light through the fixing member 21 facilitates welding of the current collector foil 12 and the resin material 13. The material of the fixing member 21 is, for example, a material that does not absorb the laser light to be emitted by a laser light irradiation device 3 described below, such as quartz glass, fluororesin, or transparent resin such as acrylic resin. However, in a case where the laser light is emitted from the z-axis negative direction side, that is, the fixing member 22 side, it is preferable that the material of the fixing member 22 is a material that is permeable to the laser light. That is, it is preferable that the materials of the fixing members 21, 22 on the side on which the laser light is emitted are materials that is permeable to the laser light.

Next, as shown in FIG. 3B, the laser light irradiation device 3 irradiates the first region on the resin material 13 with the laser light to melt the resin material 13 and to weld the current collector foil 12 and the resin material 13 (S3).

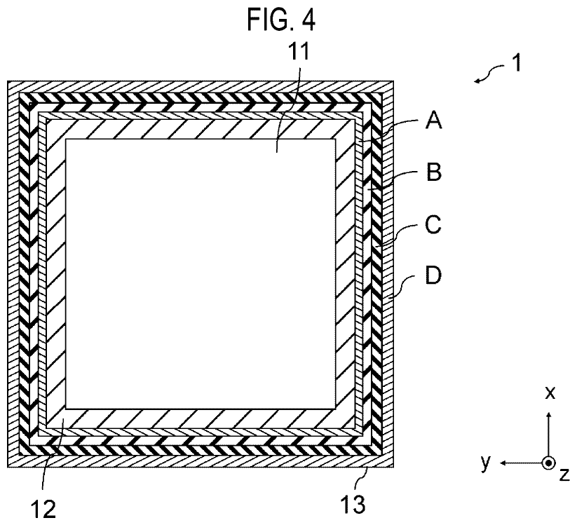

Here, the region on the resin material 13 is divided into four regions of regions A, B, C, and D from an inner side in a direction intersecting with the circumferential direction of the resin material 13, for example, as shown in FIG. 4. Note that the number of divisions of the region may be two to three or five or more. In addition, a part of one region and another region may overlap. In addition, the width of each region in a direction intersecting with the circumferential direction of the resin material 13 may not be constant.

The laser light irradiation device 3 irradiates each of the divided regions with the laser light. For example, in FIG. 3B, the first region is the region A, and the laser light is emitted to the region A. The laser light irradiation may be performed on a plurality of regions using a plurality of laser light irradiation devices 3 at the same timing as needed, or the laser light irradiation may be performed on a plurality of regions using one laser light irradiation device 3 at the same timing. In addition, the laser light irradiation device 3 may be disposed on the fixing member 22 side.

The current collector foil 12 of the region A portion is heated by the laser light irradiation shown in FIG. 3B, and the resin material 13 of the region A portion is melted as shown in FIG. 3C. After the resin material 13 is melted, the resin material 13 is cooled and then hardened again, so that the current collector foil 12 and the resin material 13 are welded.

The wavelength of the laser light may be a wavelength at which the metal that constitutes the current collector foil 12 can absorb the laser light. In addition, the irradiation time and the irradiation intensity of the laser light are controlled such that the resin material 13 is appropriately melted. In addition, the scanning method of the laser light is determined according to the purpose of manufacturing the electrode 1, and, for example, an XY plotter method, a galvano scanning method, a processing stage driving method, a laser oscillator driving method, or a scanning method in which these scanning methods are combined is used.

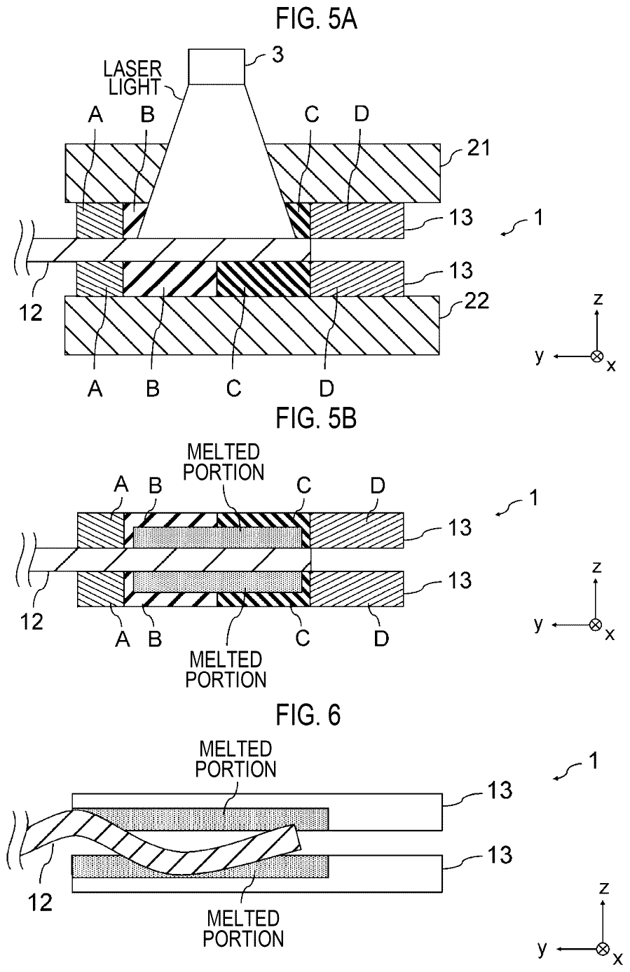

Next, as shown in FIG. 5A, the laser light irradiation device 3 irradiates the region on the resin material 13 with the laser light in a region different from the first region, melts the resin material 13, and causes the current collector foil 12 and the resin material 13 to be welded (S4). For example, in FIG. 5A, the regions B and C are the second regions. By irradiating the regions B and C with the laser light, as shown in FIG. 5B, the resin material 13 in the regions B and C is melted, and the current collector foil 12 and the resin material 13 are welded.

S4 may be started before S3 ends. That is, there may be a timing at which S3 and S4 are simultaneously executed.

Next, in S4, after a region different from the first region is irradiated with the laser light, a determination is made as to whether there is another region to be irradiated with the laser light (S5). When the region to be irradiated with the laser light exists (Yes in S5), the process returns to S4, and the laser light irradiation is further performed. For example, the laser light irradiation may be performed on the region A as S3, the laser light irradiation may be performed on the region B as S4, and the laser light irradiation may be performed on the region C by executing S4 again. In addition, there may be a region, such as the region D, that is not irradiated with the laser light at this time. On the other hand, in a case where there is no other region to be irradiated with the laser light (No in S5), the process is terminated.

The timing and the irradiation region of the laser light irradiation with respect to the resin material 13 are divided. As a result, the welding step can be executed such that the non-melted portion is always present at the contact portion between the current collector foil 12 and the resin material 13 (for example, region B and C in FIG. 4, and region A in FIG. 5B). Since the non-melted portion restrains the current collector foil 12, the effect of suppressing deformation of the current collector foil 12 is obtained. On the other hand, as shown in FIG. 6, in a case where the entire contact portion between the current collector foil 12 and the resin material 13 is simultaneously melted, the current collector foil 12 is not restrained, and the deformation of the current collector foil 12 is caused.

The order of the laser light irradiation in the plurality of regions on the resin material 13 is appropriately determined such that the current collector foil 12 and the resin material 13 can be accurately welded. However, the region that is irradiated with the laser light in S3 is preferably located inwardly of the region that is irradiated with laser light in S4 in the direction intersecting with the circumferential direction of the resin material 13. That is, the order in which the laser light is emitted to the region B and the region C in S3 and the region A in S4 is compared with the order in which the laser light is emitted to the region A in S3 and the region B and the region C in S4, and the order in which the laser light is emitted to the region A in S3 and the region B and the region C in S4 is more preferable.

By emitting the laser light in this order, it is possible to weld the current collector foil 12 and the resin material 13 from the inner side in the direction intersecting with the outer circumferential direction of the resin material 13. As a result, first, the region A is first welded in S3, and the current collector foil 12 of the region A portion is restrained, so that the deformation of the current collector foil 12 located inwardly of the region A in the direction intersecting with the circumferential direction of the resin material 13 is suppressed. Next, even when the regions B and Care melted in S4, the current collector foil 12 of the region A is restrained, and thus deformation of the current collector foil 12 located outwardly of the region A in the direction intersecting with the circumferential direction of the resin material 13 is suppressed. As a result, deformation of the entire peripheral edge portion of the current collector foil 12 is suppressed.

In addition, a width of the region of the resin material 13 that is irradiated with the laser light in S3 in a direction intersecting with the circumferential direction of the resin material 13 is preferably narrower than the width of the region of the resin material 13 that is irradiated with the laser light in S4. That is, the order in which the laser light is emitted to the regions A and B in S3 and the region C in S4 is compared with the order in which the laser light is emitted to the region A in S3 and the regions B and C in S4, and the order in which the laser light is emitted to the region A in S3 and the regions B and C in S4 is more preferable.

By narrowing the width of the region on which the laser light is emitted in S3, the melted portion in S3 is reduced. As a result, the effect of suppressing deformation of the current collector foil 12 on the inner side in the direction intersecting the circumferential direction of the resin material 13 is further enhanced.

As described above, the method of manufacturing an electrode according to the embodiment of the present disclosure includes dividing a region to be irradiated with a laser light into a plurality of regions, melting a resin material in each region, and welding the metal foil to the resin material. As a result, the non-melted portion always restrains the metal foil even during the welding step, so that deformation of the metal foil is reduced. As a result, it is possible to provide a method of manufacturing an electrode that can improve the processing accuracy when the metal foil and the resin material are welded.

What is claimed is:

1. A method of manufacturing an electrode in which a metal foil is coated with a resin material having thermoplasticity, the method comprising:
a laminating step of laminating the resin material on a peripheral edge portion of the metal foil;
a first welding step of irradiating a first region among a plurality of regions with laser light when a region on the resin material is divided into the regions in a direction intersecting with a circumferential direction of the resin material to melt the resin material and then welding the metal foil and the resin material to each other; and
a second welding step of irradiating a second region different from the first region among the regions with the laser light after starting the first welding step to melt the resin material and then welding the metal foil and the resin material to each other.

2. The method according to claim 1, wherein the first region is provided inwardly of the second region in the direction intersecting with the circumferential direction.

3. The method according to claim 2, wherein a width of the first region in the direction intersecting with the circumferential direction is shorter than a width of the second region in the direction intersecting with the circumferential direction.

4. The method according to claim 1, further comprising a fixing step of fixing, using a fixing member, the metal foil and the resin material that are laminated, the fixing member being made of a material that is permeable to the laser light, wherein the laser light is transmitted through the fixing member and is emitted to the region on the resin material in the first welding step and the second welding step.
